(19) United States
(12) Patent Application Publication
(10) Pub. No.: US 2014/0012491 A1
(43) Pub. Date: Jan. 9, 2014

(54) TRAVELING SUPPORT APPARATUS AND TRAVELING SUPPORT METHOD

(71) Applicants: Tomonori Akiyama, Susono-shi (JP); Shinji Igarashi, Susono-shi (JP); Yuki Yoshihama, Susono-sji (JP)

(72) Inventors: Tomonori Akiyama, Susono-shi (JP); Shinji Igarashi, Susono-shi (JP); Yuki Yoshihama, Susono-sji (JP)

(73) Assignee: TOYOTA JIDOSHA KABUSHIKI KAISHA, Toyota-shi, Aichi-ken (JP)

(21) Appl. No.: 13/375,367

(22) PCT Filed: Mar. 17, 2011
(86) PCT No.: PCT/JP11/56445

§ 371 Date: Nov. 30, 2011

(51) Int. Cl. G06F 17/00

(52) U.S. Cl. CPC G06F 17/00
USPC 701/300

(57) ABSTRACT

An object of the present invention is to provide a technique in order to carry out the driving support in conformity with the running feeling of a driver. The present invention resides in a traveling support apparatus for carrying out support of assist or warning in order to avoid any departure of a vehicle from a traveling route set on the basis of a traveling-prohibited region or a road indication to indicate a lane boundary, wherein a boundary of the traveling route is set by reflecting a distance which is provided in a lateral direction of the vehicle until present time between the subject vehicle and the traveling-prohibited region or the road indication to indicate the lane boundary. Accordingly, it is possible to set the boundary of the traveling route which is favorable for the driver and which is appropriate corresponding to each road. Therefore, it is possible to carry out the driving support in conformity with the running feeling of the driver.

### TECHNICAL FIELD

The present invention relates to a traveling support apparatus and a traveling support method.

### BACKGROUND ART

A technique has been disclosed, wherein one of the left side and the right side is defined by a reference lane mark extending along a traveling-scheduled road for a subject vehicle, and the other side is defined by a virtual lane mark separated from the reference lane mark in the widthwise direction of the traveling-scheduled road, when the spacing distance in the widthwise direction of the road between the left side lane mark and the right side lane mark is gradually widened at positions disposed farther from the subject vehicle, and thus the spacing distance is widened to such an extent that the situation is inappropriate in view of the definition of the traveling area (see, for example, Patent Document 1).

### PRIOR ART REFERENCES

### Patent Documents

[First Patent Document] Japanese patent application laid-open No. JP2009-214786A

[Second Patent Document] Japanese patent application laid-open No. JP2008-059324A

[Third Patent Document] Japanese patent application laid-open No. JP2006-321299A

### SUMMARY OF THE INVENTION

### Problems to be Solved by the Invention

However, in the case of the technique described in Patent Document 1, the road widths of the respective roads are different from each other depending on each of the roads on which the subject vehicle travels, while it is impossible to define any appropriate lane mark corresponding to each of the roads. Therefore, it has been impossible to perform any driving support in conformity with the running feeling (traveling feeling) of a driver.

The present invention has been made taking the foregoing circumstances into consideration, an object of which is to provide a technique in order to carry out the driving support in conformity with the running feeling of a driver.

### Means for Solving the Problems

The present invention adopts the following construction. That is, the present invention resides in a traveling support apparatus for carrying out support of assist or warning in order to avoid any departure of a vehicle from a traveling route set on the basis of a traveling-prohibited region or a road indication to indicate a lane boundary, wherein:

a boundary of the traveling route is set by reflecting a distance which is provided in a lateral direction of the vehicle until present time between the subject vehicle and the traveling-prohibited region or the road indication to indicate the lane boundary.

The road indication to indicate the lane boundary is exemplified, for example, by the median strip and the partition between the lanes including, for example, lines such as white lines, yellow lines, and dotted lines, road studs, and light-emitting members provided on the road surface, and the boundary (partition line) between the roadway and the portion other than the roadway such as the boundary between the asphalt and the gravel. The traveling-prohibited region is exemplified by the obstacle including, for example, guard rails, fences, side walls, curbstones, walkers, bicycles, and other vehicles, and the area having any difference in height with respect to the flat surface for allowing the vehicle to travel thereon, including, for example, draining channels, recesses, and steps. The traveling-prohibited region includes the area in which the vehicle cannot travel as well as the area in which it is not intended to allow the vehicle to travel and the area in which the travel of the vehicle is unfavorable. The distance in the lateral direction of the vehicle is the distance which is provided in the direction perpendicular to the traveling direction of the vehicle.

According to the present invention, the boundary of the traveling route is set by reflecting the past distance which is provided in the lateral direction of the vehicle between the subject vehicle and the traveling-prohibited region or the road indication to indicate the lane boundary. Therefore, the boundary of the traveling route is set while considering the distance which is favorably selected by a driver between the subject vehicle and the traveling-prohibited region or the road indication to indicate the lane boundary. Accordingly, it is possible to set the boundary of the traveling route which is favorable for the driver and which is appropriate corresponding to each of the roads. Therefore, it is possible to carry out the driving support in conformity with the running feeling of the driver.

It is preferable that the boundary of the traveling route is set on a side opposite to a side on which the traveling-prohibited region or the road indication to indicate the lane boundary exists.

According to the present invention, the boundary of the traveling route is set while considering the distance which is favorably selected by the driver, on the side opposite to the side on which the traveling-prohibited region or the road indication to indicate the lane boundary exists. Accordingly, it is possible to set the boundary of the traveling route which is favorable for the driver and which is appropriate corresponding to each of the roads. Therefore, it is possible to carry out the driving support in conformity with the running feeling of the driver.

It is preferable that the distance, which is provided in the lateral direction of the vehicle until the present time between the subject vehicle and the traveling-prohibited region or the road indication to indicate the lane boundary, is statistically calculated.

The statistic calculation herein includes a case in which an average value or a medium value in a predetermined period of time is calculated and a case in which the calculation is performed while considering a variance with respect to an average value.

According to the present invention, the past distance, which is provided in the lateral direction of the vehicle between the subject vehicle and the traveling-prohibited region or the road indication to indicate the lane boundary, can be calculated most appropriately.

The present invention adopts the following construction. That is, the present invention resides in a traveling support method for carrying out support of assist or warning in order to avoid any departure of a vehicle from a traveling route set on the basis of a traveling-prohibited region or a road indication to indicate a lane boundary, wherein:

a boundary of the traveling route is set by reflecting a distance which is provided in a lateral direction of the vehicle until present time between the subject vehicle and the traveling-prohibited region or the road indication to indicate the lane boundary.

Accordingly, it is also possible to carry out the driving support in conformity with the running feeling of the driver.

### Effect of the Invention

According to the present invention, it is possible to carry out the driving support in conformity with the running feeling of the driver.

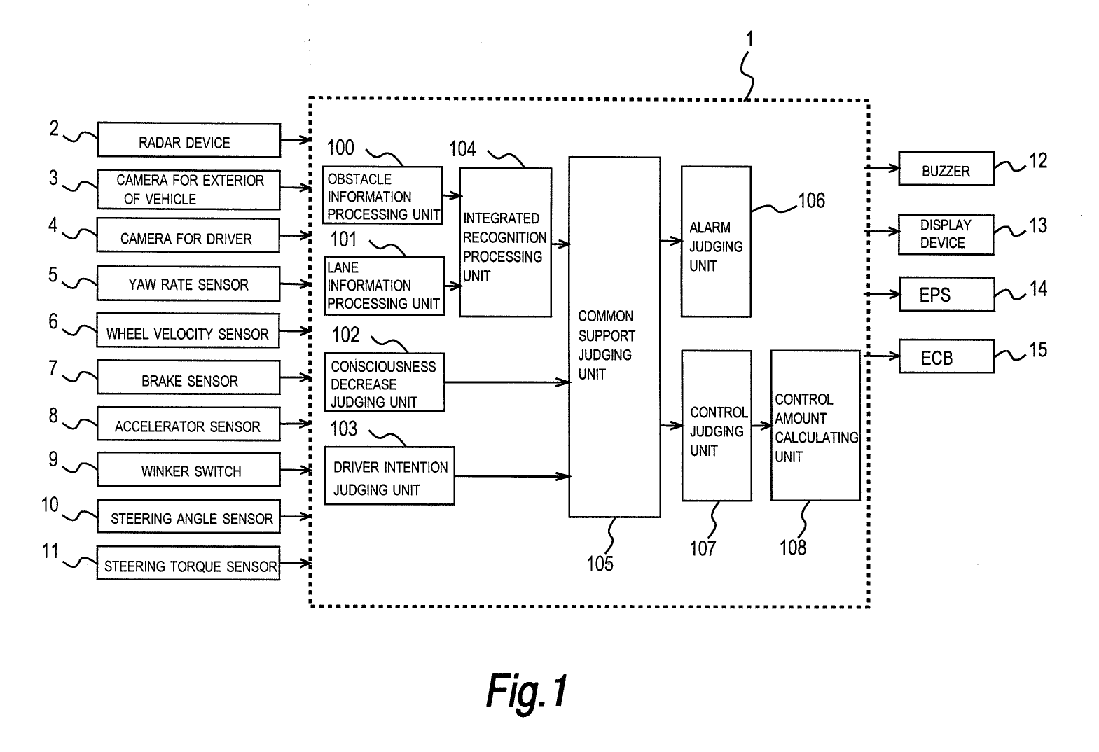

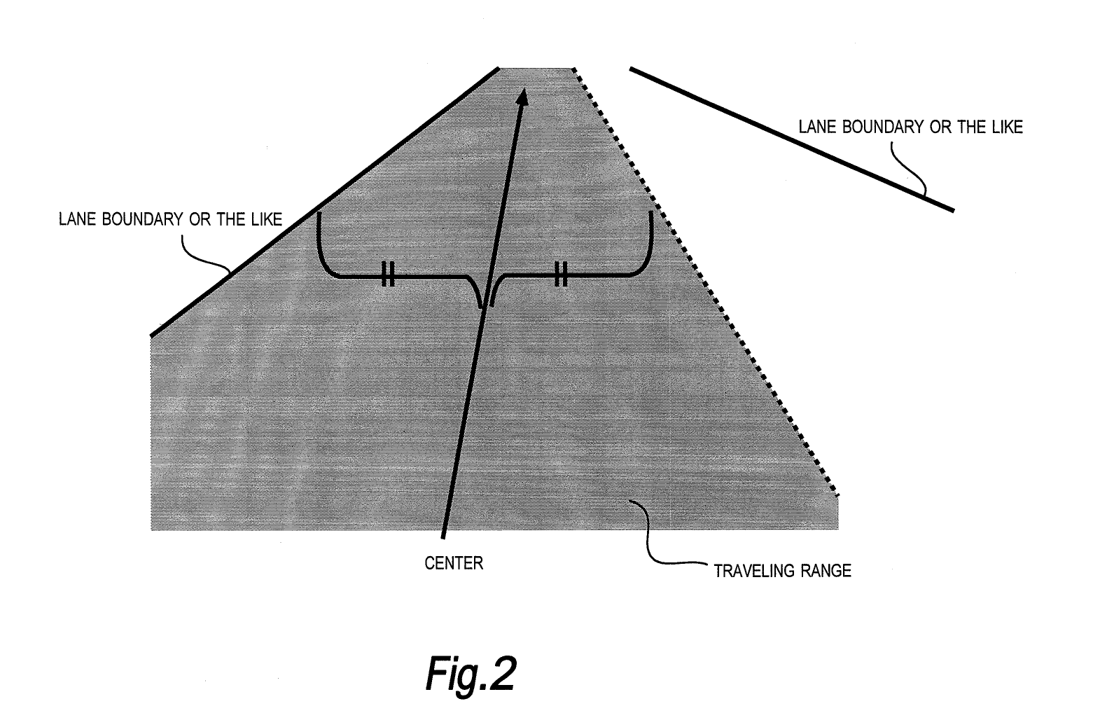

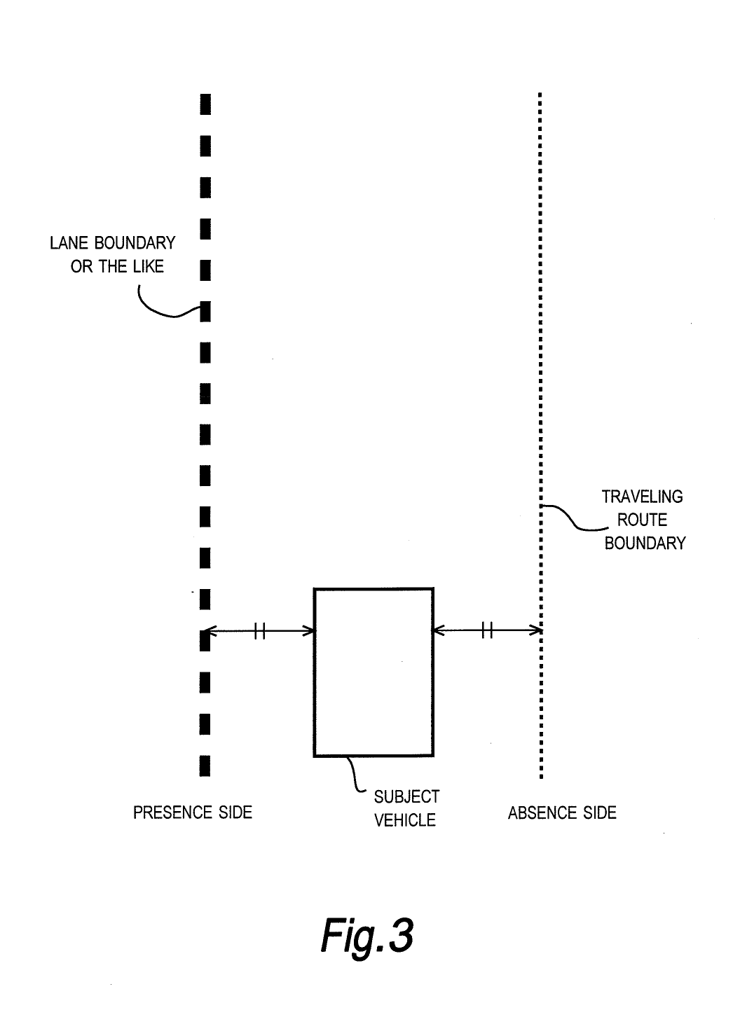

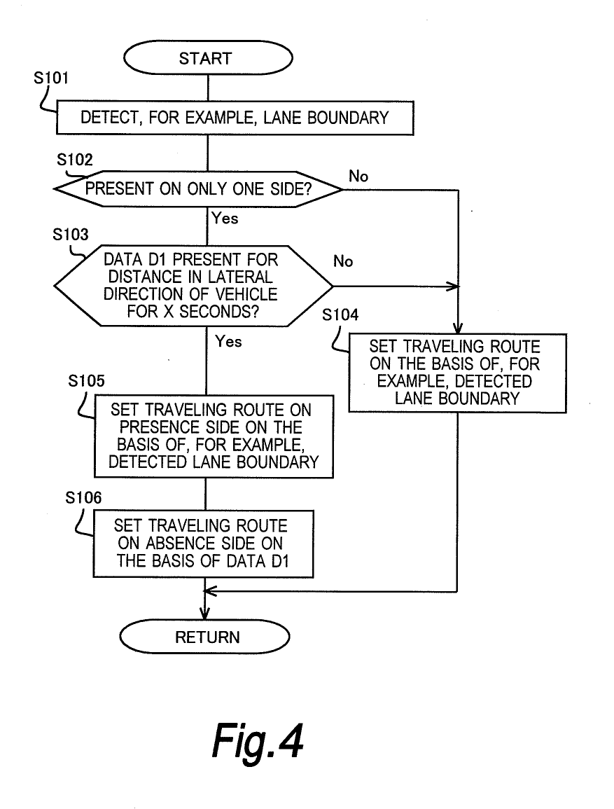

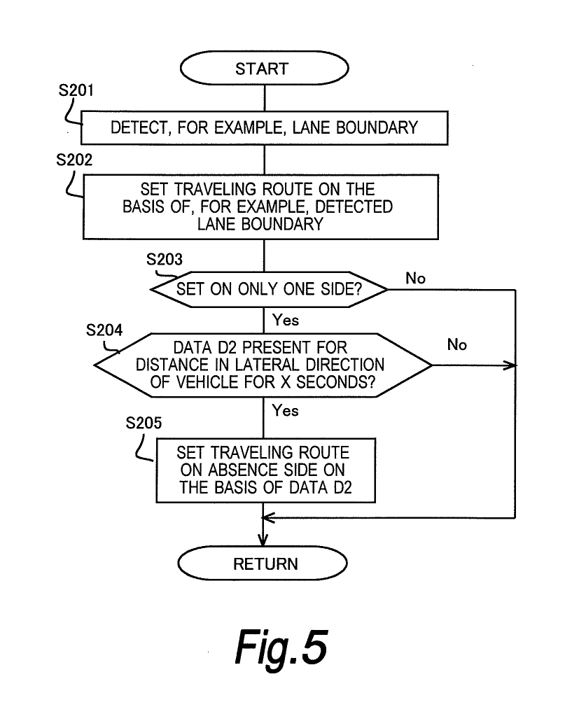

### BRIEF DESCRIPTION OF THE DRAWINGS

[FIG. 1] shows a block diagram illustrating an arrangement of a driving support apparatus according to a first embodiment of the present invention, as classified by functions.

[FIG. 2] shows a traveling range of a driver when a traveling-prohibited region or a road indication to indicate a lane boundary is present on only one side of a subject vehicle according to the first embodiment.

[FIG. 3] shows a situation in which a boundary of the traveling route, which is equivalent to that provided on the presence side, is set on the absence side according to the first embodiment.

[FIG. 4] shows a flow chart illustrating a traveling route setting control routine 1 when the traveling-prohibited region or the road indication to indicate the lane boundary is present on only one side according to the first embodiment.

[FIG. 5] shows a flow chart illustrating a traveling route setting control routine 2 when a traveling-prohibited region or a road indication to indicate a lane boundary is present on only one side according to a second embodiment.

### BEST MODES FOR CARRYING OUT THE INVENTION

A specified embodiment of the present invention will be explained below. An explanation will now be made about the driving support apparatus (traveling support apparatus, for example, LDW and LDP) for performing the driving support process in order that a lane and a traveling-prohibited region is recognized, a traveling route is set on the basis of the recognized lane and the traveling-prohibited region, and any departure of a subject vehicle from the traveling route is avoided. The driving support process referred to herein is executed prior to the collision damage mitigating process to be executed when the vehicle is stopped in the case of emergency or when it is inevitable to cause the collision between the vehicle and the obstacle. In the driving support process, the support is performed so that the traveling itself can be continued. Therefore, the driving support apparatus of the present invention is different from any driving support apparatus (for example, PCS) which performs the collision damage mitigating process. The arrangement explained in the following embodiment is illustrative of a mode for carrying out the present invention. The construction of the present invention is not limited thereto.

### First Embodiment

### (Driving Support Apparatus)

FIG. 1 shows a block diagram illustrating an arrangement of a driving support apparatus (traveling support apparatus) according to a first embodiment of the present invention, as classified by functions. As shown in FIG. 1, an electronic control unit (ECU) 1 for supporting the driving, which constitutes the driving support apparatus, is carried on a vehicle.

ECU 1 is the electronic control unit which is provided with, for example, CPU, ROM, RAM, backup RAM, and I/O interface. A radar device 2, a camera 3 for the exterior of the vehicle, a camera 4 for a driver, and various sensors including, for example, a yaw rate sensor 5, a wheel velocity sensor 6, a brake sensor 7, an accelerator sensor 8, a winker switch 9, a steering angle sensor 10, and a steering torque sensor 11 are electrically connected to ECU 1. Output signals of the sensors are inputted into ECU 1.

The radar device 2 is attached to a front portion of the vehicle so that the millimeter wave is transmitted frontwardly from the vehicle and the reflected wave, which is reflected by any obstacle disposed outside the vehicle, is received. Accordingly, the radar device 2 outputs the information (for example, coordinate information) in relation to the relative position of the obstacle with respect to the vehicle. The camera 3 for the exterior of the vehicle is arranged at a position at which the scene in front of the vehicle can be captured in the field in a vehicle chamber, and an image in front of the vehicle is outputted. The camera 4 for the driver is arranged at a position at which the driver can be captured in the field in the vehicle chamber, and an image of the driver is outputted. The yaw rate sensor 5 is attached to a vehicle body, and an electric signal, which correlates with the yaw rate of the vehicle, is outputted. The wheel velocity sensor 6 is attached to a wheel of the vehicle, and an electric signal, which correlates with the travel velocity of the vehicle, is outputted.

The brake sensor 7 is attached to a brake pedal disposed in the vehicle chamber, and an electric signal, which correlates with the operation torque (pedaling force) of the brake pedal, is outputted. The accelerator sensor 8 is attached to an accelerator pedal disposed in the vehicle chamber, and an electric signal, which correlates with the operation torque (pedaling force) of the accelerator pedal, is outputted. The winker switch 9 is attached to a winker lever disposed in the vehicle chamber, and an electric signal, which correlates with the direction indicated by a winker (direction indicator), is outputted when the winker lever is operated. The steering angle sensor 10 is attached to a steering rod connected to a steering wheel disposed in the vehicle chamber, and an electric signal, which correlates with the angle of rotation from the neutral position of the steering wheel, is outputted. The steering torque sensor 11 is attached to the steering rod, and an electric signal, which correlates with the torque (steering torque) inputted into the steering wheel, is outputted.

Further, various devices, which include, for example, a buzzer 12, a display device 13, an electric power steering (EPS) 14, and an electronic control brake (ECB) 15, are connected to ECU 1. The various devices are electrically controlled by ECU 1.

The buzzer 12 is attached in the vehicle chamber, and the buzzer 12 outputs, for example, a warning sound. The display device 13 is attached in the vehicle chamber, and the display device 13 displays various messages and the warning lamp. The electric power steering (EPS) 14 assists the operation of the steering wheel by utilizing the torque generated by an electric motor. The electronic control brake (ECB) 15 electrically adjusts the operating hydraulic pressure (brake hydraulic pressure) of the friction brake provided for each of the wheels.

ECU 1 has the following functions in order to control the various devices by utilizing the output signals of the various sensors as described above. That is, ECU 1 is provided with an obstacle information processing unit 100, a lane information processing unit 101, a consciousness decrease judging unit 102, a driver intention judging unit 103, an integrated recognition processing unit 104, a common support judging unit 105, an alarm judging unit 106, a control judging unit 107, and a control amount calculating unit 108.

The obstacle information processing unit 100 approximately determines the regression straight line with which a plurality of traveling-prohibited regions can be avoided, on the basis of the coordinate information about the plurality of traveling-prohibited regions such as obstacles and the like outputted from the radar device 2, and the obstacle information processing unit 100 generates the coordinate information of the regression straight line and the information which includes, for example, the yawing angle of the vehicle with respect to the regression straight line. When the traveling-prohibited region, which is for example, a single obstacle, is detected by the radar device 2, the obstacle information processing unit 100 also generates the coordinate information of the traveling-prohibited region and the information which relates to the yawing angle of the vehicle with respect to the traveling-prohibited region. The obstacle information processing unit 100 may generate the information which relates to the traveling-prohibited region, on the basis of the image photographed by the camera 3 for the exterior of the vehicle. The traveling-prohibited region is exemplified by the obstacle including, for example, guard rails, fences, side walls, curbstones, walkers, bicycles, and other vehicles, and the area having any difference in height with respect to the flat surface for allowing the vehicle to travel thereon, including, for example, draining channels, recesses, and steps. The traveling-prohibited region includes the area in which the vehicle cannot travel as well as the area in which it is not intended to allow the vehicle to travel and the area in which the travel of the vehicle is unfavorable.

The lane information processing unit 101 generates the information which relates to the lane and the information which relates to the attitude or posture of the vehicle with respect to the lane, on the basis of the image photographed by the camera 3 for the exterior of the vehicle. The information, which relates to the lane, includes the information which relates to the road indication to indicate the lane boundary and the information which relates to the width of the lane defined by the road indication. The road indication to indicate the lane boundary is exemplified, for example, by the median strip and the partition between the lanes including, for example, lines (partition lines) such as white lines, yellow lines, and dotted lines, road studs, and light-emitting members provided on the road surface, and the boundary between the roadway and the portion other than the roadway such as the boundary between the asphalt and the gravel. The information, which relates to the attitude or posture of the vehicle with respect to the lane, includes the information which relates to the distance between the vehicle and the road indication to indicate the lane boundary, the information which relates to the offset amount of the vehicle position with respect to the central portion of the lane, and the information which relates to the yawing angle in the traveling direction of the vehicle with respect to the road indication to indicate the lane boundary. When the vehicle carries a navigation system, the lane information processing unit 101 may generate the information which relates to the lane, from the GPS information and the map information possessed by the navigation system.

The consciousness decrease judging unit 102 judges the degree of consciousness decrease (degree of awakening) of the driver on the basis of the image photographed by the camera 4 for the driver. The consciousness decrease judging unit 102 calculates the eye-closed time and the eye-closed frequency of the driver from the image photographed by the camera 4 for the driver. If the eye-closed time or the eye-closed frequency exceeds an upper limit value, it is judged that the consciousness of the driver is lowered (it is judged that the degree of awakening is low). Further, the consciousness decrease judging unit 102 calculates the time in which the direction of the face of the driver and/or the direction of the line of sight is/are deviated from the traveling direction of the vehicle, from the image photographed by the camera 4 for the driver. If the calculated time exceeds an upper limit value, it may be judged that the driver looks aside.

The driver intention judging unit 103 judges whether or not the change of the operation amount of the brake pedal, the change of the operation amount of the accelerator pedal, and/or the change of the operation (steering) amount of the steering wheel results from the intention of the driver on the basis of the output signals of the wheel velocity sensor 6, the brake sensor 7, the accelerator sensor 8, the winker switch 9, the steering angle sensor 10, and the steering torque sensor 11.

The integrated recognition processing unit 104 sets the traveling route on which the vehicle can travel, on the basis of the information which is generated by the obstacle information processing unit 100 and the information which is generated by the lane information processing unit 101. The integrated recognition processing unit 104 determines the yawing angle of the vehicle with respect to the traveling route boundary and the offset amount of the vehicle with respect to the central portion of the traveling route. Basically, the traveling route is set to have the lane width itself. In other words, the lane itself corresponds to the boundary of the traveling route. In the case of a road on which the width of the lane is narrow, it is inevitable for the driver to cause the departure of the vehicle from the lane in some cases. In relation thereto, the integrated recognition processing unit 104 may set the traveling route while causing the departure from the lane, on the basis of the information which relates to the road indication to indicate the lane boundary and the information which relates to the traveling-prohibited region existing around the lane, in relation to the road having the narrow width of the lane. In other words, the integrated recognition processing unit 104 may set a temporary traveling route which causes the departure from the road indication, from the road indication to indicate the lane boundary, and the integrated recognition processing unit 104 may set a regular traveling route which causes the departure from the road indication, from the temporary traveling route and the traveling-prohibited region. Further, if the integrated recognition processing unit 104 receives the information which relates to a single traveling-prohibited region from the obstacle information processing unit 100, the traveling route may be set by extending the length of the traveling-prohibited region in parallel to the road. That is, the integrated recognition processing unit 104 may set the traveling route such that the traveling-prohibited region, which is detected as the point on the coordinate, is regarded as the line on the coordinate. In this procedure, the amount of extension (length of the line) may be prolonged when the output signal of the wheel velocity sensor 6 (vehicle velocity) is high and when the yawing angle of the vehicle with respect to the line is large as compared with when the vehicle velocity is low and when the yawing angle is small.

The degree of recognition (level of recognition) LR is imparted to the traveling route set by the integrated recognition processing unit 104. The degree of recognition LR of the traveling route expresses, as a numerical value, the accuracy (reliability) of the traveling route which is set by combining the accuracy (reliability of the presence) of the traveling-prohibited region based on the information generated by the obstacle information processing unit 100 and the accuracy (reliability of the presence) of the road indication to indicate the lane boundary based on the information generated by the lane information processing unit 101. The higher the degree of recognition LR is, the more satisfactory the situation is. In other words, the degree of recognition LR of the traveling route is the degree to judge whether or not the warning or the assist is performed. If the degree of recognition LR is not less than a first threshold value (predetermined threshold value), the warning or the assist is performed. If the degree of recognition LR is lower than the first threshold value (predetermined threshold value), the warning or the assist is not performed. A specified calculating method for calculating the degree of recognition LR of the traveling route by the integrated recognition processing unit 104 uses a map which represents the relationship between the degree of recognition LR of the traveling route and the number of detection edge points. The accuracy (reliability of the presence) of the traveling-prohibited region based on the information generated by the obstacle information processing unit 100 and the accuracy (reliability of the presence) of the road indication to indicate the lane boundary based on the information generated by the lane information processing unit 101 are proportional to the number of detection edge points when they are detected respectively. In other words, the larger the number of the detection edge points is, the higher the accuracy of the traveling-prohibited region and the accuracy of the road indication to indicate the lane boundary are. Therefore, it is possible to calculate the degree of recognition LR of the traveling route by incorporating, into the map, the numbers of the detection edge points of the traveling-prohibited region and the road indication to indicate the lane boundary used when the traveling route is set. If the number of the detection edge points is less than a predetermined number of points, it is also allowable that the traveling route itself is not set.

The common support judging unit 105 judges whether or not the driving support process is executed, on the basis of the information generated by the integrated recognition processing unit 104, the judgment result of the consciousness decrease judging unit 102, and the judgment result of the driver intention judging unit 103. If it is judged by the consciousness decrease judging unit 102 that the consciousness of the driver is lowered or the driver looks aside, the common support judging unit 105 may permit the execution of the driving support process. If it is judged by the driver intention judging unit 103 that the driver performs the intentional operation, the common support judging unit 105 may restrict the execution of the driving support process. If the degree of recognition LR of the traveling route, which is calculated by the integrated recognition processing unit 104, is not less than the predetermined first threshold value Rth, the common support judging unit 105 executes the driving support process unconditionally. On the other hand, if the degree of recognition LR of the traveling route is lower than the predetermined first threshold value Rth, the driving support process is not executed. Alternatively, if the degree of recognition LR of the traveling route is lower than the predetermined first threshold value Rth, it is also allowable that the driving support process can be executed when a certain special condition holds. In this procedure, the first threshold value Rth is the threshold value which is provided to judge whether or not the driving support process is executed unconditionally by using only the degree of recognition LR of the traveling route. If the degree of recognition LR of the traveling route is higher than the first threshold value Rth, the driving support process can be executed unconditionally. Therefore, if the degree of recognition LR of the traveling route is lower than the first threshold value Rth, the execution of the driving support process is ordinarily restricted. However, the driving support process may be executed, for example, if at least any one of the degree of awakening of the driver and the degree of the driving operation is low, even under the condition in which the degree of recognition LR of the traveling route is lower than the first threshold value Rth and the execution of the driving support process is restricted.

The alarm judging unit 106 determines the beeping timing of the buzzer 12 and/or the display timing of the warning lamp or the warning message displayed by the display device 13, when the common support judging unit 105 permits the execution of the driving support process. The alarm judging unit 106 may perform the beeping of the buzzer 12 and/or the display of the warning lamp or the warning message displayed by the display device 13, when the distance, which is provided between the vehicle and the traveling route boundary in the widthwise direction of the vehicle, is not more than a predetermined distance, when the distance is zero, or when the vehicle exceeds the traveling route boundary. The alarm judging unit 106 performs not only the beeping of the buzzer 12 on the basis of the traveling route boundary and/or the display of the warning lamp or the warning message displayed by the display device 13 but the alarm judging unit 106 may also increase the beeping of the buzzer 12 and/or increase the display of the warning lamp or the warning message displayed by the display device 13, as the direction is deviated from the traveling route more greatly, while widely recognizing the traveling route boundary in view of the potential. The alarm judging unit 106 may perform the beeping of the buzzer 12 and/or the display of the warning lamp or the warning message displayed by the display device 13 when the time (TLC: time to lane crossing), which is required for the vehicle to arrive at the traveling route boundary in the widthwise direction of the vehicle, is not more than a predetermined time. When the vehicle enters a curve or when the vehicle travels along the curve, then the alarm judging unit 106 may perform the beeping of the buzzer 12 and/or the display of the warning lamp or the warning message displayed by the display device 13, if the distance, which is provided between the vehicle and the traveling route boundary in the traveling direction of the vehicle, is not more than a predetermined distance, when the distance is zero, or when the vehicle exceeds the traveling route boundary. When the vehicle enters a curve or when the vehicle travels along the curve, then the alarm judging unit 106 may perform the beeping of the buzzer 12 and/or the display of the warning lamp or the warning message displayed by the display device 13, when the time, which is required for the vehicle to arrive at the traveling route boundary in the traveling direction of the vehicle, is not more than a predetermined time. The timing, at which the alarm judging unit 106 performs the beeping of the buzzer 12 and/or the display of the warning lamp or the warning message displayed by the display device 13 as described above, corresponds to the support execution timing.

In this procedure, the predetermined distance and the predetermined time, based on which the alarm judging unit 106 performs the beeping of the buzzer 12 and/or the display of the warning lamp or the warning message displayed by the display device 13, reside in the values which are changed depending on the output signal of the wheel velocity sensor 6 (vehicle velocity) and the output signal of the yaw rate sensor 5 (yaw rate). The predetermined distance is set to be long or the predetermined time is set to be long when the vehicle velocity is high as compared with when the vehicle velocity is low. The predetermined distance is set to be long or the predetermined time is set to be long when the yaw rate is large as compared with when the yaw rate is small.

The method for giving the warning to the driver is not limited to the beeping of the buzzer 12 and the display of the warning lamp or the warning message displayed by the display device 13, for which it is also allowable to adopt, for example, such a method that the tightening torque of a seat belt is changed continuously or intermittently.

The control judging unit 107 determines whether or not the electric power steering (EPS) 14 and/or the electronic control brake (ECB) 15 is/are operated in order to avoid the departure from the traveling route if the execution of the driving support process is permitted by the common support judging unit 105. The control judging unit 107 may operate the electric power steering (EPS) 14 and/or the electronic control brake (ECB) 15 when the distance, which is provided between the vehicle and the traveling route boundary in the widthwise direction of the vehicle, is not more than a predetermined distance, when the distance is zero, or when the vehicle exceeds the traveling route boundary. Alternatively, the control judging unit 107 may operate the electric power steering (EPS) 14 and/or the electronic control brake (ECB) 15 if the time, which is required for the vehicle to arrive at the traveling route boundary in the widthwise direction of the vehicle, is not more than a predetermined time. When the vehicle enters a curve or when the vehicle travels along a curve, then the control judging unit 107 may operate the electric power steering (EPS) 14 and/or the electronic control brake (ECB) 15 when the distance, which is provided between the vehicle and the traveling route boundary in the traveling direction of the vehicle, is not more than a predetermined distance, when the distance is zero, or when the vehicle exceeds the traveling route boundary. When the vehicle enters a curve or when the vehicle travels along a curve, then the control judging unit 107 may operate the electric power steering (EPS) 14 and/or the electronic control brake (ECB) 15, if the time, which is required for the vehicle to arrive at the traveling route boundary in the traveling direction of the vehicle, is not more than a predetermined time. The timing or timings, at which the control judging unit 107 operates the electric power steering (EPS) 14 and/or the electronic control brake (ECB) 15, correspond(s) to the support execution timing.

The predetermined distance and the predetermined time, which are used by the control judging unit 107, are changed depending on the vehicle velocity and the yaw rate in the same manner as the predetermined distance and the predetermined time which are used by the alarm judging unit 106. However, it is preferable that the predetermined distance and the predetermined time, which are used by the control judging unit 107, are set to be shorter than the predetermined distance and the predetermined time which are used by the alarm judging unit 106.

The control amount calculating unit 108 calculates the control amounts of the electric power steering (EPS) 14 and the electronic control brake (ECB) 15 when the control judging unit 107 generates the request for operating the electric power steering (EPS) 14 and the electronic control brake (ECB) 15. Further, the control amount calculating unit 108 operates the electric power steering (EPS) 14 and the electronic control brake (ECB) 15 in accordance with the calculated control amounts. The control amount calculating unit 108 calculates the target yaw rate required to avoid the departure from the traveling route by using, as the parameters, the information generated by the integrated recognition processing unit 104, the output signal of the wheel velocity sensor 6 (vehicle velocity), and the output signal of the yaw rate sensor 5 (yaw rate). In particular, the control amount calculating unit 108 calculates the target yaw rate Ytrg in accordance with the following expression provided that D represents the relative distance with respect to the traveling route boundary, V represents the velocity of the vehicle (vehicle velocity), and θ represents the yawing angle of the vehicle with respect to the traveling route boundary:

Ytrg=(θ·V sin θ)/D

The control amount calculating unit 108 determines the control amount (steering torque) of the electric power steering (EPS) 14 and the control amount (hydraulic pressure of the brake) of the electronic control brake (ECB) 15 by using the target yaw rate Ytrg as the argument or parameter. In this procedure, the relationship between the target yaw rate Ytrg and the steering torque and the relationship between the target yaw rate Ytrg and the brake hydraulic pressure may be previously mapped. If the target yaw rate Ytrg is smaller than a predetermined value (maximum value of the yaw rate at which the departure from the traveling route can be successfully avoided by means of only the steering), the brake hydraulic pressure of the electronic control brake (ECB) 15 may be set to zero. When the electronic control brake (ECB) 15 is operated, if different brake hydraulic pressures are applied to the friction brakes for the left and right wheels of the vehicle, then any yaw rate, which interferes with the yaw rate generated by the electric power steering (EPS) 14, is generated. Therefore, it is desirable that equivalent brake hydraulic pressures are applied to the friction brakes for the left and right wheels. The control amount calculating unit 108 not only operates the electric power steering (EPS) 14 and the electronic control brake (ECB) 15 by using the traveling route boundary as the reference, but the control amount calculating unit 108 may also increase the control amounts as the direction is deviated from the traveling route more greatly, while widely recognizing the traveling route boundary in view of the potential.

The method for decelerating the vehicle is not limited to the method in which the friction brake is operated by means of the electronic control brake (ECB) 15. It is also allowable to use a method in which the kinetic energy of the vehicle is converted (regenerated) into the electric energy and a method in which the transmission gear ratio of the transmission is changed to increase the engine brake.

According to the driving support apparatus described above, it is possible to warn the driver of the departure from the traveling route set on the basis of the lane and the traveling-prohibited region such as the obstacle or the like, and it is possible to assist the operation for avoiding the departure from the traveling route.

### (Traveling Route Setting Control 1 When Traveling-Prohibited Region or Road Indication to Indicate Lane Boundary is Present on Only One Side)

The integrated recognition processing unit 104 sets the traveling route on which the subject vehicle can travel, on the basis of the information generated by the obstacle information processing unit 100 and the information generated by the lane information processing unit 101.

In this procedure, the traveling-prohibited region or the road indication to indicate the lane boundary exists on only one side of the subject vehicle in some cases. One side with respect to the subject vehicle, on which the traveling-prohibited region or the road indication to indicate the lane boundary exists, is referred to as “presence side”, and the other side with respect to the subject vehicle, on which the traveling-prohibited region or the road indication to indicate the lane boundary does not exist, is referred to as “absence side”. In this case, the boundary of the traveling route can be set on the presence side on the basis of the traveling-prohibited region or the road indication to indicate the lane boundary which exists. However, the traveling-prohibited region or the road indication to indicate the lane boundary, which may serve as the basis, is absent on the absence side. Therefore, it is impossible to set any appropriate traveling route boundary, and the traveling route is excessively narrow or excessively wide for the driver. Further, as for the road on which the vehicle travels, the road width differs among the respective roads. Therefore, if the traveling route boundary is uniformly set on the absence side, the traveling route is also excessively narrow or excessively wide. As described above, it has been impossible to set any traveling route boundary which is appropriate corresponding to each of the roads and which is favorable for the driver. It has been impossible to perform the driving support in conformity with the running feeling of the driver.

In view of the above, in this embodiment, the traveling route boundary is set on the absence side by reflecting the distance which is provided in the lateral direction of the vehicle until the present time between the subject vehicle and the traveling-prohibited region or the road indication to indicate the lane boundary on the presence side.

FIG. 2 shows a traveling range of a driver when a traveling-prohibited region or a road indication to indicate a lane boundary is present on only one side of a subject vehicle. As shown in FIG. 2, the driver has such a character that the traveling range, in which the subject vehicle travels, is determined, for example, from the range of the road surface, and the driver travels to trace the center of the traveling range. When this character is utilized, it is possible to perform the driving support in conformity with the running feeling without any feeling of incongruity for the driver, if the traveling route boundary, which is provided with the equal distance from the subject vehicle, is also set on the absence side in the same manner as on the presence side, because the driver traces the subject vehicle to the center of the traveling range determined by himself/herself.

FIG. 3 shows a situation in which a boundary of the traveling route, which is equivalent to that provided on the presence side, is set on the absence side. As shown in FIG. 3, the driver traces the subject vehicle to the center of the traveling range determined by himself/herself. Therefore, the distance in the lateral direction of the vehicle, which is in conformity with the feeling of the driver, is provided until arrival at the present time with respect to the traveling-prohibited region or the road indication to indicate the lane boundary on the presence side. Therefore, it is possible to calculate the distance in the lateral direction of the vehicle until arrival at the present time between the subject vehicle and the traveling-prohibited region or the road indication to indicate the lane boundary on the presence side statistically in a predetermined time until arrival at the present time. In this procedure, the method for statistically calculating the distance is exemplified, for example, by a case in which the average value or the medium value in the predetermined time is calculated, and a case in which the calculation is performed while considering the variance for the average value. In this way, the data is calculated for the distance in the lateral direction of the vehicle between the subject vehicle and the traveling-prohibited region or the road indication to indicate the lane boundary on only one side (presence side) in relation to the predetermined time (for example, X seconds) until arrival at the present time, which is stored beforehand. The traveling route boundary is set on the absence side on the basis of the data of the distance having been stored. The trace of the subject vehicle to the center of the traveling range determined by the driver himself/herself is in conformity with the running feeling of the driver. Therefore, in this procedure, the traveling route boundaries are set at approximately the same distance on the presence side and the absence side. However, even when the traveling route boundary is set, any danger does not actually exist on the absence side. Therefore, in the case of the departure from the traveling route, it is also allowable that the alarm judging unit 106 performs only the beeping of the buzzer 12 and the display of the warning lamp or the warning message displayed by the display device 13, without operating the electric power steering (EPS) 14 and the electronic control brake (ECB) 15. The support execution timing on the absence side may be also delayed as compared with the support execution timing on the presence side.

As described above, when the traveling route boundary, which is the same as or equivalent to the traveling route boundary set on the presence side, is set on the absence side, the traveling route boundary is set on the absence side while considering the distance favorably selected by the driver. Accordingly, it is possible to set the traveling route boundary which is favorable for the driver and which is appropriate corresponding to each of the roads. Therefore, it is possible to carry out the driving support in conformity with the running feeling of the driver.

### (Traveling Route Setting Control Routine 1 When Traveling-Prohibited Region or Road Indication to Indicate Lane Boundary is Present on Only One Side)

An explanation will be made on the basis of a flow chart shown in FIG. 4 about the traveling route setting control routine 1 to be executed when any oncoming vehicle exists, in the integrated recognition processing unit 104. FIG. 4 shows a flow chart illustrating a traveling route setting control routine 1 when the traveling-prohibited region or the road indication to indicate the lane boundary is present on only one side. This routine is repeatedly executed by the integrated recognition processing unit 104 of ECU 1 every time when a predetermined time elapses.

When the routine shown in FIG. 4 is started, in S101, the detection is performed for the traveling-prohibited region or the road indication to indicate the lane boundary recognized previously by the integrated recognition processing unit 104. The traveling-prohibited region or the road indication to indicate the lane boundary is detected, for example, by the radar device 2 and/or the camera 3 for the exterior of the vehicle.

In S102, it is discriminated whether or not the traveling-prohibited region or the road indication to indicate the lane boundary exists on only one side with respect to the subject vehicle. If the affirmative judgment is made in S102, the routine proceeds to S103. If the negative judgment is made in S102, the routine proceeds to S104.

In S103, it is discriminated whether or not the data D1 is present in relation to the distance in the lateral direction of the vehicle between the subject vehicle and the traveling-prohibited region or the road indication to indicate the lane boundary on only one side (presence side) for a predetermined time (for example, X seconds) until arrival at the present time. If the affirmative judgment is made in S103, the routine proceeds to S105. If the negative judgment is made in S103, the routine proceeds to S104.

In S104, the traveling route is set on the basis of the traveling-prohibited region or the road indication to indicate the lane boundary which is detected. That is, if the routine proceeds from S102 to this step, the traveling-prohibited regions or the road indications to indicate the lane boundaries are present on both sides of the subject vehicle. Therefore, the traveling route boundaries are set on the both sides of the subject vehicle on the basis of the traveling-prohibited regions or the road indications to indicate the lane boundaries disposed on the both sides of the subject vehicle. On the other hand, if the routine proceeds from S103 to this step, the traveling-prohibited region or the road indication to indicate the lane boundary is present on one side of the subject vehicle. Therefore, the traveling route boundary is set on one side of the subject vehicle which is the presence side, on the basis of the traveling-prohibited region or the road indication to indicate the lane boundary disposed on only one side of the subject vehicle. After the process of this step, this routine is once completed.

In S105, the traveling route is set on the presence side on the basis of the traveling-prohibited region or the road indication to indicate the lane boundary which is detected.

In S106, the traveling route boundary is set on the absence side from the data D1 of the distance in the lateral direction of the vehicle between the subject vehicle and the traveling-prohibited region or the road indication to indicate the lane boundary on only one side (presence side) in relation to the predetermined time (for example, X seconds) until arrival at the present time. Specifically, the average value is calculated for the data D1 of the distance in the lateral direction of the vehicle between the subject vehicle and the traveling-prohibited region or the road indication to indicate the lane boundary on the presence side. The distance is provided by using the calculated average value to set the traveling route boundary on the absence side in the lateral direction of the vehicle on the absence side of the subject vehicle. It is preferable that the setting is previously applied so that the support and the support execution timing for the traveling route boundary on the absence side are different from the support and the support execution timing for the ordinary traveling route boundary. Accordingly, it is possible to set the traveling route boundary on the absence side by reflecting the distance until the present time in the lateral direction of the vehicle between the subject vehicle and the traveling-prohibited region or the road indication to indicate the lane boundary on only one side (presence side). In this step, the distance on the absence side is set by using the average value of the distance data in the lateral direction of the vehicle between the subject vehicle and the traveling-prohibited region or the road indication to indicate the lane boundary on the presence side. Alternatively, it is also allowable to use the medium value, the maximum value, or the minimum value, and it is also allowable to use the value obtained by adding the variance to the average value or subtracting the variance from the average value. After the process of this step, this routine is once completed.

According to this routine as described above, the traveling route boundaries can be set on the both sides of the subject vehicle, even when the traveling-prohibited region or the road indication to indicate the lane boundary is present on only one side. In this procedure, the support and the support execution timing for the traveling route boundary on the absence side can be different from those of the ordinary case. Therefore, it is possible to perform the traveling support without causing any feeling of incongruity and any troublesome affair for the driver.

The processes as described above are performed by the alarm judging unit 106, the control judging unit 107, and the control amount calculating unit 108 by using the traveling route set by this routine.

### Second Embodiment

In the first embodiment described above, the traveling route boundary on the absence side is set from the data D1 of the distance in the lateral direction of the vehicle between the subject vehicle and the traveling-prohibited region or the road indication to indicate the lane boundary on only one side (presence side) for the predetermined time (for example, X seconds) until the present time. However, the method for setting the traveling route boundary on the absence side is not limited thereto. In this embodiment, at first, the traveling route boundary is set on the presence side by reflecting the distance in the lateral direction of the vehicle between the subject vehicle and the traveling-prohibited region or the road indication to indicate the lane boundary on only one side (presence side) for a predetermined time (for example, X second) until the present time. Further, the traveling route boundary on the absence side is set from the data D2 of the distance in the lateral direction of the vehicle between the subject vehicle and the traveling route boundary on the presence side for a predetermined time (for example, X second) until the present time. In this embodiment, the feature thereof will be explained. Other constructions are omitted from the explanation.

### (Traveling Route Setting Control 2 When Traveling-Prohibited Region or Road Indication to Indicate Lane Boundary is Present on Only One Side)

In this embodiment, the distance in the lateral direction of the vehicle, which is in conformity with the feeling of the driver until arrival at the present time, is provided with respect to the traveling route boundary on the presence side set to correspond to the traveling-prohibited region or the road indication to indicate the lane boundary on the presence side, because the driver traces the subject vehicle to the center of the traveling range determined by himself/herself. Therefore, it is possible to statistically calculate the distance in the lateral direction of the vehicle until the present time between the subject vehicle and the traveling route boundary on the presence side for the predetermined time until arrival at the present time. In this procedure, the method for statistically calculating the distance is exemplified, for example, by a case in which the average value or the medium value in the predetermined time is calculated, and a case in which the calculation is performed while considering the variance for the average value. In this way, the data is calculated for the distance in the lateral direction of the vehicle between the subject vehicle and the traveling-prohibited region or the road indication to indicate the lane boundary on only one side (presence side) in relation to the predetermined time (for example, X seconds) until arrival at the present time, which is stored beforehand. The traveling route boundary is set on the absence side on the basis of the data of the distance having been stored. In this procedure, the trace of the subject vehicle to the center of the traveling range determined by the driver himself/herself is in conformity with the running feeling of the driver. Therefore, the traveling route boundaries are set at approximately the same distance on the presence side and the absence side. However, even when the traveling route boundary is set, any danger does not actually exist on the absence side. Therefore, in the case of the departure from the traveling route, it is also allowable that the alarm judging unit 106 performs only the beeping of the buzzer 12 and the display of the warning lamp or the warning message displayed by the display device 13, without operating the electric power steering (EPS) 14 and the electronic control brake (ECB) 15. The support execution timing on the absence side may be delayed as compared with the support execution timing on the presence side.

As described above, when the traveling route boundary, which is equivalent to that on the presence side, is set on the absence side, the traveling route boundary is set on the absence side while considering the distance favorably selected by the driver. Accordingly, it is possible to set the traveling route boundary which is favorable for the driver and which is appropriate corresponding to each of the roads. Therefore, it is possible to carry out the driving support in conformity with the running feeling of the driver.

### (Traveling Route Setting Control Routine 2 When Traveling-Prohibited Region or Road Indication to Indicate Lane Boundary is Present on Only One Side)

An explanation will be made on the basis of a flow chart shown in FIG. 5 about the traveling route setting control routine 2 to be executed when any oncoming vehicle exists, in the integrated recognition processing unit 104. FIG. 5 shows a flow chart illustrating a traveling route setting control routine 2 when the traveling-prohibited region or the road indication to indicate the lane boundary is present on only one side. This routine is repeatedly executed by the integrated recognition processing unit 104 of ECU 1 every time when a predetermined time elapses.

When the routine shown in FIG. 5 is started, in S201, the detection is performed for the traveling-prohibited region or the road indication to indicate the lane boundary recognized previously by the integrated recognition processing unit 104. The traveling-prohibited region or the road indication to indicate the lane boundary is detected, for example, by the radar device 2 and/or the camera 3 for the exterior of the vehicle.

In S202, the traveling route or the traveling routes is/are set on one side or both sides on which the traveling-prohibited region or the road indication to indicate the lane boundary exists, on the basis of the traveling-prohibited region or the road indication to indicate the lane boundary which is detected. Specifically, the traveling route or the traveling routes is/are set on one side or both sides on which the traveling-prohibited region or the road indication to indicate the lane boundary exists, by reflecting the distance in the lateral direction of the vehicle until the present time between the subject vehicle and the traveling-prohibited region or the road indication to indicate the lane boundary. The traveling route, which is set in this procedure, is based on the traveling-prohibited region or the road indication to indicate the lane boundary. Therefore, the traveling route is usually set on the road indication to indicate the lane boundary or on the side deviated toward the subject vehicle as compared with the traveling-prohibited region or the road indication to indicate the lane boundary.

In S203, it is discriminated whether or not the traveling route boundary is set on only one side (presence side) with respect to the subject vehicle. If the affirmative judgment is made in S203, the routine proceeds to S204. If the negative judgment is made in S203, this routine is once completed.

In S204, it is discriminated whether or not the data D2 is present in relation to the distance in the lateral direction of the vehicle between the subject vehicle and the traveling route boundary on only one side (presence side) for a predetermined time (for example, X seconds) until arrival at the present time. If the affirmative judgment is made in S204, the routine proceeds to S205. If the negative judgment is made in S204, this routine is once completed.

In S205, the traveling route boundary is set on the absence side from the data D2 of the distance in the lateral direction of the vehicle between the subject vehicle and the traveling route boundary on only one side (presence side) in relation to the predetermined time (for example, X seconds) until arrival at the present time. Specifically, the average value is calculated for the distance data in the lateral direction of the vehicle between the subject vehicle and the traveling route boundary on the presence side. The distance is provided by using the calculated average value to set the traveling route boundary on the absence side in the lateral direction of the vehicle on the absence side of the subject vehicle. It is preferable that the setting is previously applied so that the support and the support execution timing for the traveling route boundary on the absence side are different from the support and the support execution timing for the ordinary traveling route boundary. Accordingly, it is possible to set the traveling route boundary on the absence side by reflecting the distance until the present time in the lateral direction of the vehicle between the subject vehicle and the traveling route boundary based on the traveling-prohibited region or the road indication to indicate the lane boundary on only one side (presence side). In this step, the distance on the absence side is set by using the average value of the data D2 of the distance in the lateral direction of the vehicle between the subject vehicle and the traveling route boundary on the presence side. Alternatively, it is also allowable to use the medium value, and it is also allowable to use the value obtained by adding the variance to the average value or subtracting the variance from the average value. After the process of this step, this routine is once completed.

According to this routine as described above, the traveling route boundaries can be set on the both sides of the subject vehicle, even when the traveling-prohibited region or the road indication to indicate the lane boundary is present on only one side. In this procedure, the support and the support execution timing for the traveling route boundary on the absence side can be different from those of the ordinary case. Therefore, it is possible to perform the traveling support without causing any feeling of incongruity and any troublesome affair for the driver.

The processes as described above are performed by the alarm judging unit 106, the control judging unit 107, and the control amount calculating unit 108 by using the traveling route set by this routine.

### (Other Features)

The traveling support apparatus according to the present invention is not limited to the embodiments described above, to which various changes or modifications may be applied within a scope without deviating from the gist or essential characteristics of the present invention. The foregoing embodiment has been explained assuming that LDP is assumed as the traveling support apparatus, and the traveling route is set on the presence side on the basis of the traveling-prohibited region or the road indication to indicate the lane boundary. However, there is no limitation thereto. A virtual traveling route boundary may be also set on the absence side when the road indication to indicate the lane boundary exists on only one side in the case of an apparatus such as LKA or the like. The embodiments described above are also embodiments of the traveling support method according to the present invention.

### EXPLANATION OF REFERENCE NUMERALS AND CHARACTERS

1: ECU
2: radar device
3: camera for exterior of vehicle
4: camera for driver
5: yaw rate sensor
6: wheel velocity sensor
7: brake sensor
8: accelerator sensor
9: winker switch
10: steering angle sensor
11: steering torque sensor
12: buzzer
13: display device
14: EPS
15: ECB
100: obstacle information processing unit
101: lane information processing unit
102: consciousness decrease judging unit
103: driver intention judging unit
104: integrated recognition processing unit
105: common support judging unit
106: alarm judging unit
107: control judging unit
108: control amount calculating unit.

1. A traveling support apparatus for carrying out support of assist or warning in order to avoid any departure of a vehicle from a traveling route set on the basis of a traveling-prohibited region or a road indication to indicate a lane boundary, wherein:
a boundary of the traveling route is set by reflecting a distance which is provided in a lateral direction of the vehicle until present time between the subject vehicle and the traveling-prohibited region or the road indication to indicate the lane boundary.

2. The traveling support apparatus according to claim 1, wherein the boundary of the traveling route is set on a side opposite to a side on which the traveling-prohibited region or the road indication to indicate the lane boundary exists.

3. The traveling support apparatus according to claim 1, wherein the distance, which is provided in the lateral direction of the vehicle until the present time between the subject vehicle and the traveling-prohibited region or the road indication to indicate the lane boundary, is statistically calculated.

4. A traveling support method for carrying out support of assist or warning in order to avoid any departure of a vehicle from a traveling route set on the basis of a traveling-prohibited region or a road indication to indicate a lane boundary, wherein:
a boundary of the traveling route is set by reflecting a distance which is provided in a lateral direction of the vehicle until present time between the subject vehicle and the traveling-prohibited region or the road indication to indicate the lane boundary.
